(19) United States
(12) Patent Application Publication
(10) Pub. No.: US 2025/0290787 A1
(43) Pub. Date: Sep. 18, 2025

(54) EDUCATIONAL BALANCE

(71) Applicant: hand2mind, Inc., Vernon Hills, IL (US)

(72) Inventors: Jared Ganrude, Indian Creek, IL (US); Brian McMahon, Palatine, IL (US); Dennis Blackmore, Norfolk (GB)

(21) Appl. No.: 18/592,102

(22) Filed: Mar. 14, 2024

(51) Int. Cl. G01G 1/24; A63H 3/00; A63H 31/00

(52) U.S. Cl. CPC G01G 1/243; A63H 3/003; A63H 31/00

(57) ABSTRACT

A balance includes a central portion and a lever pivotably coupled to the central portion about a fulcrum centered along a length of the lever. The lever has opposing distal ends thereof. A display of the balance is positioned on a front surface of the central portion. The display is configured to change between a greater-than sign, an equals sign, and a less-than sign in correlation with different orientations of the lever such that the display is operable to show a symbolic relationship between respective loads positioned at the respective opposing distal ends of the lever.

### BACKGROUND

The present disclosure relates generally to a balance, sometimes referred to as a balance scale, operable for relative measurement between two masses on opposite ends of a fulcrumed lever. More particularly, the present disclosure relates to a balance configured for educational use.

### SUMMARY

In one aspect, the invention provides a balance including a central portion and a lever pivotably coupled to the central portion about a fulcrum centered along a length of the lever. The lever has opposing distal ends thereof. A display of the balance is positioned on a front surface of the central portion. The display is configured to change between a greater-than sign, an equals sign, and a less-than sign in correlation with different orientations of the lever such that the display is operable to show a symbolic relationship between respective loads positioned at the respective opposing distal ends of the lever.

In another aspect, the invention provides a balance including a mechanical display with first and second members movably positioned on a front of the balance. A gear train is configured to drive the first and second members of the/mechanical display in response to movement of a pivotable lever. The first and second members are fixed to respective gears of the gear train that are linked to rotate in equal, opposite amounts to change the mechanical display between a greater than sign, an equals sign, and a less-than sign.

### BRIEF DESCRIPTION OF THE DRAWINGS

FIG. 1 is a front perspective view of a balance according to one embodiment of the present disclosure. The balance is shown in a first configuration, displaying a greater than sign.

FIG. 2 is a front perspective view of the balance of FIG. 1. The balance is shown in a second configuration, displaying a less than sign.

FIG. 3 is a front perspective view of the balance of FIG. 1. The balance is shown in a third configuration, displaying an equals sign.

FIG. 4 is a rear elevation view of the balance in the configuration of FIG. 3. A rear panel is removed to illustrate internal components.

FIG. 5 is a rear elevation view of the balance having a lever thereof partially rotated to the configuration of FIG. 1. The rear panel is removed to illustrate internal components.

FIG. 6 is a rear elevation view of the balance having a lever thereof fully rotated to the configuration of FIG. 1. The rear panel is removed to illustrate internal components.

FIG. 7 is a rear elevation view of the balance having a lever thereof partially rotated to the configuration of FIG. 2. The rear panel is removed to illustrate internal components.

FIG. 8 is a rear elevation view of the balance having a lever thereof fully rotated to the configuration of FIG. 2. The rear panel is removed to illustrate internal components.

FIG. 9 is a detail perspective view of an interior of the balance, including a lever fulcrum and a bell crank.

FIG. 10 is a rear elevation view of the balance with a cover panel removed to illustrate a gear train thereof. The balance is in the configuration of FIG. 3.

FIG. 11 is another rear elevation view of the balance with the cover panel removed to illustrate the gear train. The balance is in the configuration of FIG. 1.

FIG. 12 is another rear elevation view of the balance with the cover panel removed to illustrate the gear train. The balance is in the configuration of FIG. 2.

FIG. 13 is a further detailed view of the gear train.

FIG. 14 illustrates an activity set including the balance.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

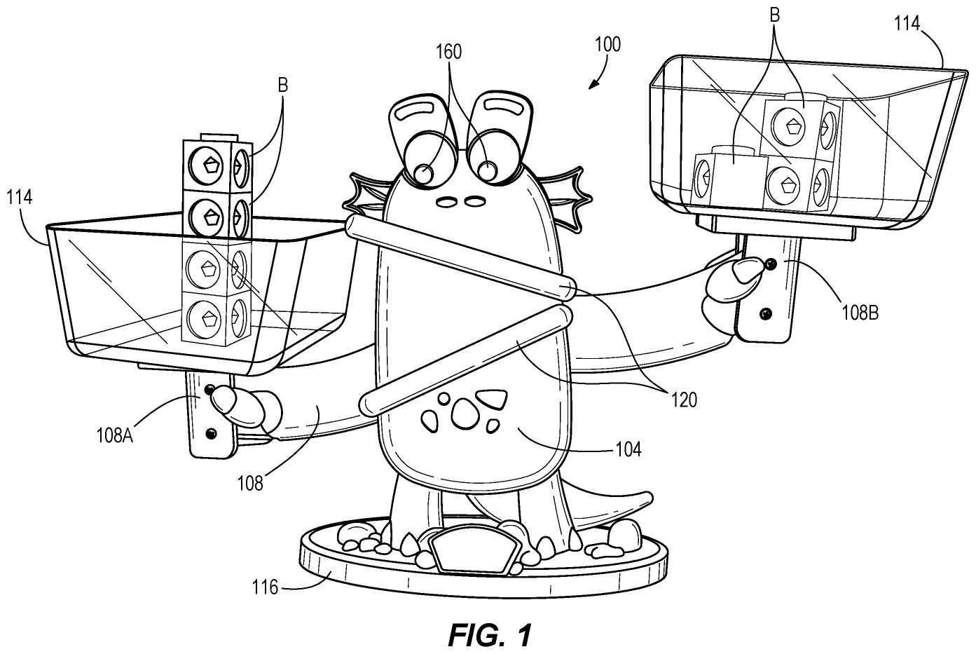

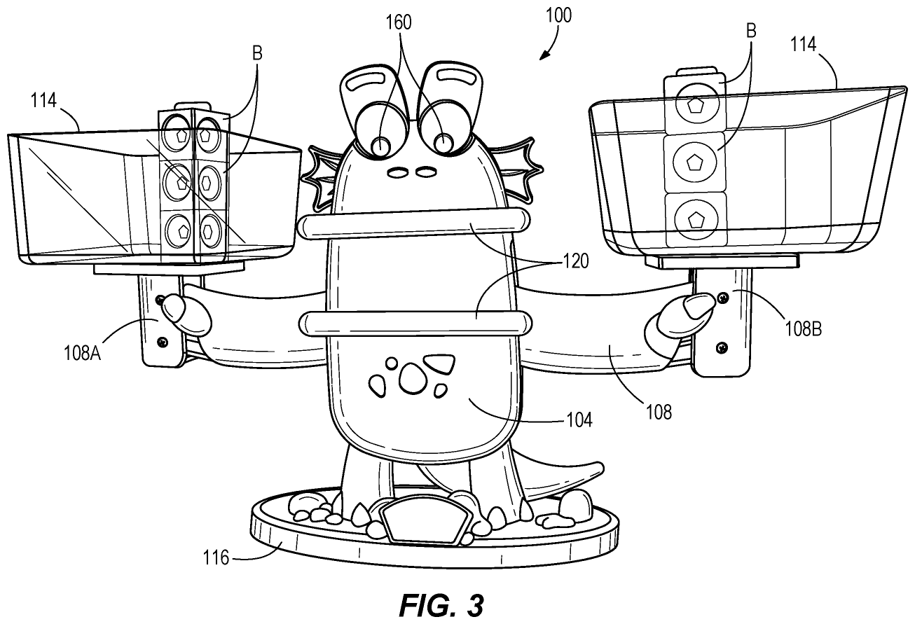

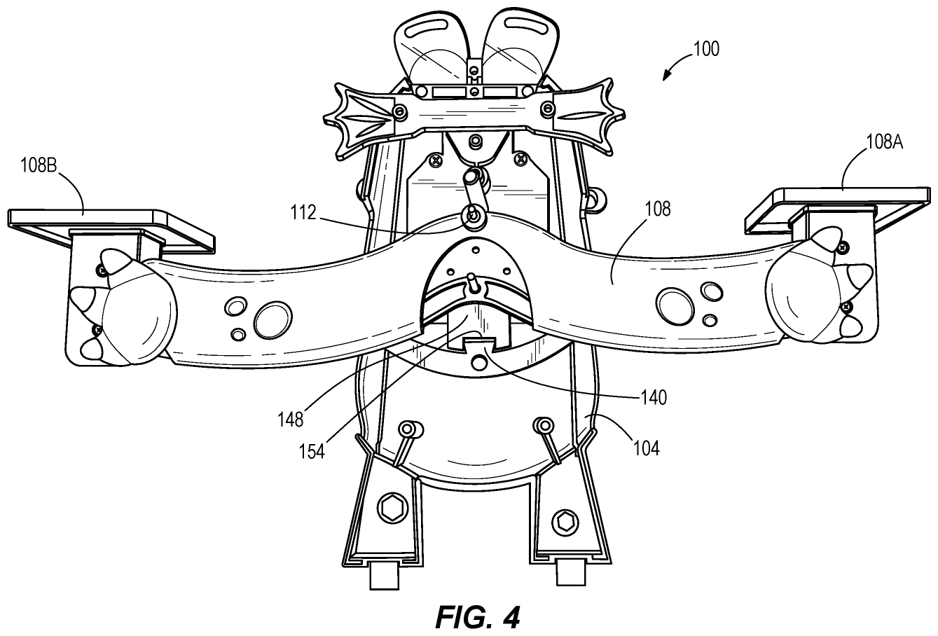

FIGS. 1-3 illustrate a balance 100 according to one construction of the present disclosure. The balance 100, as will be appreciated from the following description, is adapted for educational use in teaching children mathematical relationships. The balance 100 includes a central portion 104 and a lever 108 pivotably coupled to the central portion 104. In particular, a fulcrum 112 (FIG. 4) is centered along a length of the lever 108. The fulcrum 112 can take a number of physical constructions. The fulcrum 112 in the illustrated construction is an internal fulcrum hidden from view from the exterior. FIGS. 4-8 show a back panel of the central portion 104 removed to illustrate internal features, including the fulcrum 112 (e.g., cylindrical pin) and a mating central portion of the lever 108. The lever 108 has opposing distal ends 108A, 108B configured to receive two loads to be compared. The lever 108 is generally symmetrical such that the opposing distal ends 108A, 108B are equidistant from the fulcrum 112. The opposing distal ends 108A, 108B can include or receive respective receptacle portions 114, for example removable containers with upstanding walls. The receptacle portions can include any flat or convex structures suitable for placement of one or more objects to be balanced. For example, the receptacle portions at the distal lever ends 108A, 108B can include plates, trays, cups, boxes, etc. As shown, the illustrated construction includes clear open-topped receptacle portions 114 that define a mating interface with the distal ends 108A, 108B of the lever 108. The receptacle portions 114 can be assembled and removed simply by hand without the use of tools. The receptacle portions 114 are removed from the balance 100 in the views after FIG. 3.

The central portion 104 can include multiple parts. As illustrated, the central portion 104 includes a pedestal or body portion under which a base 116 is provided. The pedestal, which is not separately numbered, can form a main part of the central portion 104. The base 116 has a bottom surface configured to rest on a horizontal desk or table to support the balance 100 in an upright orientation. The central portion 104 can include additional parts besides the pedestal and the base 116. In the illustrated construction, the pedestal forms a head and/or body of an animal character. As such, the central portion 104 is shaped to form the face of the character on a front side thereof. The animal character can be in any suitable form of known or novel construction (e.g., human, zoological animal, monster, etc.) and may be lifelike or caricaturized. The central portion 104 may include legs extending upward from the base 116. A tail may also be provided. When the balance is configured as a character, the lever 108 can be configured as a pair of arms movable with respect to the character's body and/or face. The arms are not movable independently, but together as integral portions of the lever 108.

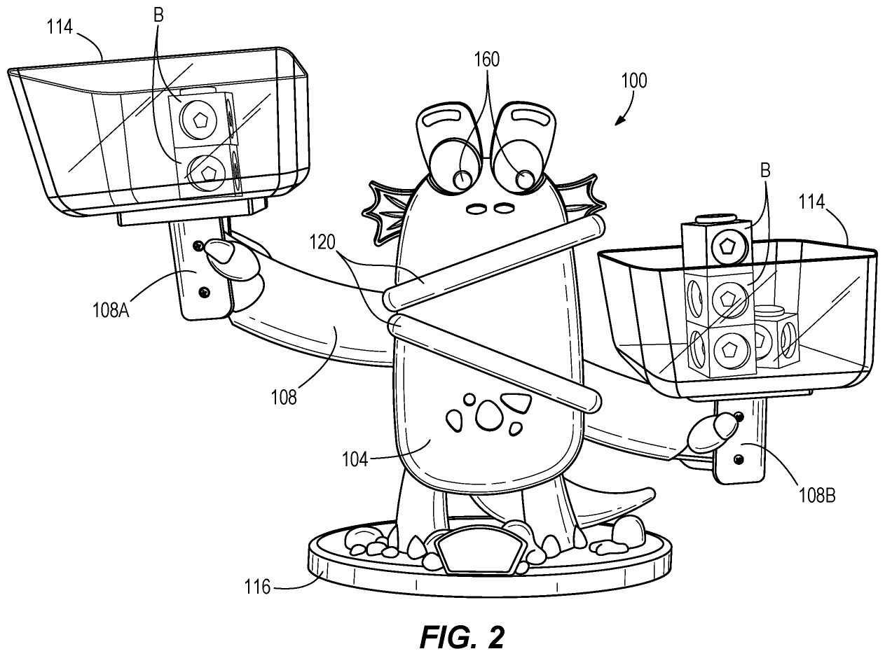

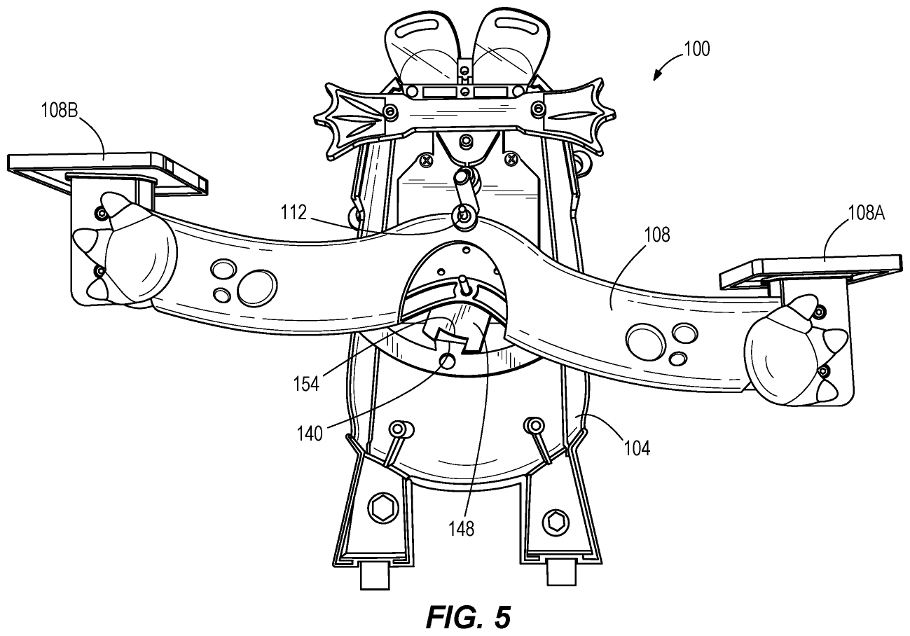

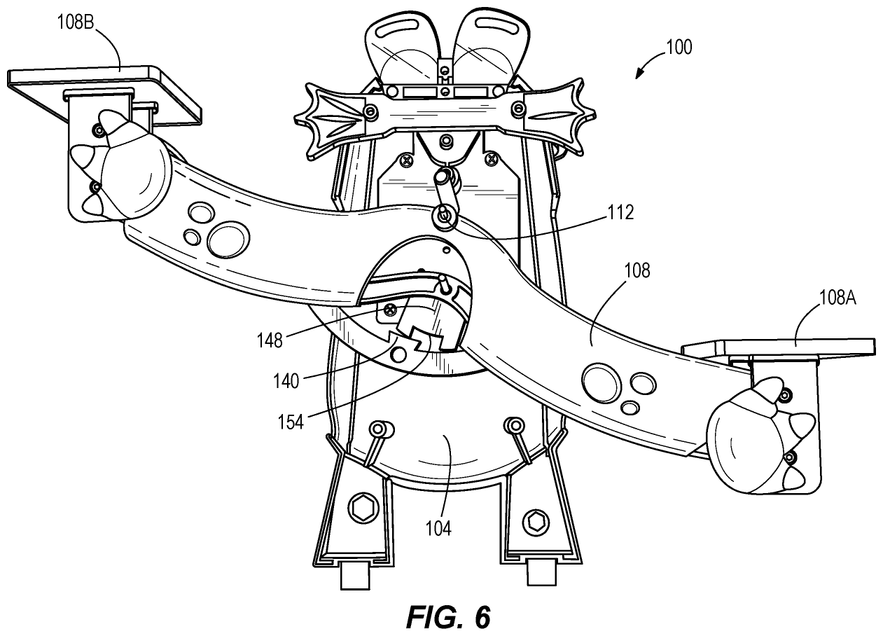

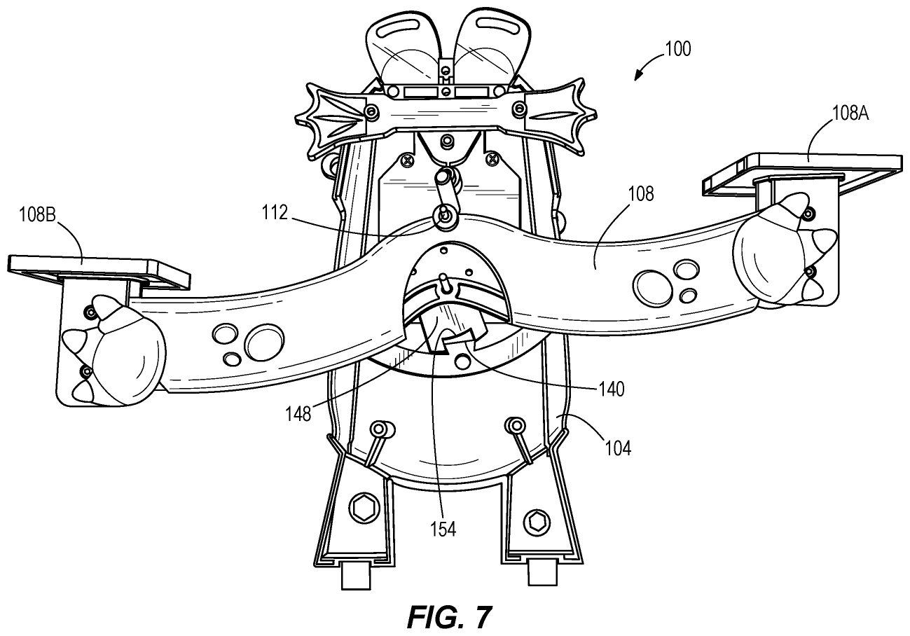

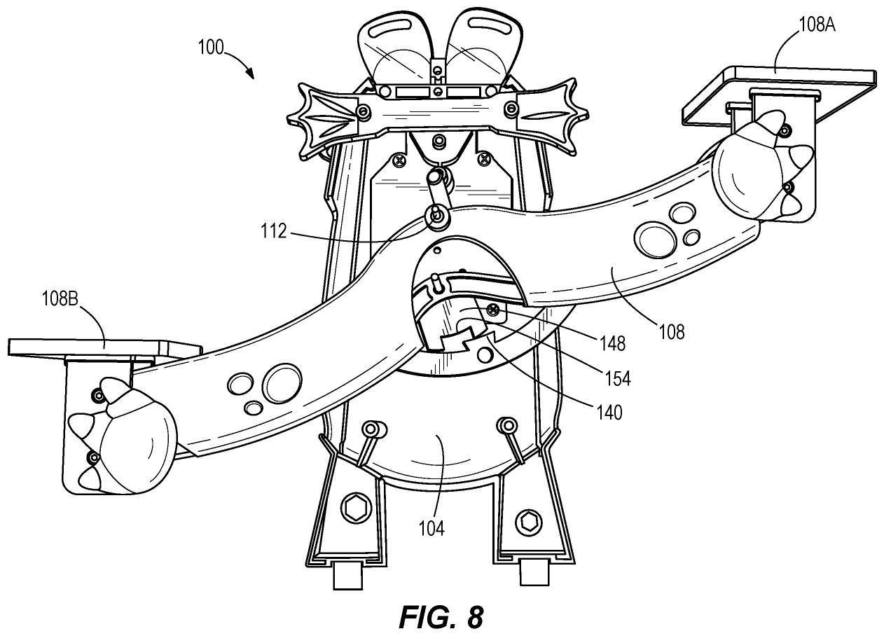

As shown in FIG. 1, the balance 100 includes a display 120. The display 120 can be positioned on a front surface of the central portion 104 to be viewable by a user of the balance 100. The display 120 is configured to change in response to movement of the lever 108. In particular, the display 120 is configured to change between a greater-than sign (FIG. 1), a less-than sign (FIG. 2), and an equals sign (FIG. 3) in correlation with different orientations of the lever 108. As such, the display 120 is operable to show a symbolic relationship (i.e., =, >, or <) between respective loads supported by the respective distal ends 108A, 108B of the lever 108. The display 120 changes between the corresponding symbols automatically as a function of the orientation of the lever 108, without requiring any user interaction. When the loads are provided as a plurality of same-weight objects B (e.g., connectable blocks, FIGS. 1-3), the numbers of objects are compared by the display 120 of the balance 100 in a mathematical expression of: equals, greater than, or less than. Although discussed in further detail below, the rear view of FIG. 4 corresponds to the “equals” configuration of FIG. 3. In the rear views of FIGS. 5 and 6, the lever 108 is rotated partially and fully in a first direction, both of which correspond to the “greater than” configuration of FIG. 1. In the rear views of FIGS. 7 and 8, the lever 108 is rotated partially and fully in a first direction, both of which correspond to the “less than” configuration of FIG. 2.

Children learning foundational mathematical concepts in early education benefit significantly from hands-on learning, also known as experiential learning. Hands-on learning is part of contemporary elementary school math standards and helps kids learn through physical models that demonstrate abstract concepts. A popular instructional approach to help kids progress from the physical to the abstract is known as the CRA math model which stands for Concrete-Representational-Abstract. Children start with “concrete”, which is something they can experience and touch, then migrate through representations of physical models (drawings and visual models) to the abstract (symbols, numbers, equations). Thus, the balance 100 being a working hands-on device represents an educational breakthrough that links the concrete hands-on experience of comparing masses with the abstract concepts of equals, greater than and less than, as well as the abstract symbols of: =, >, and <.

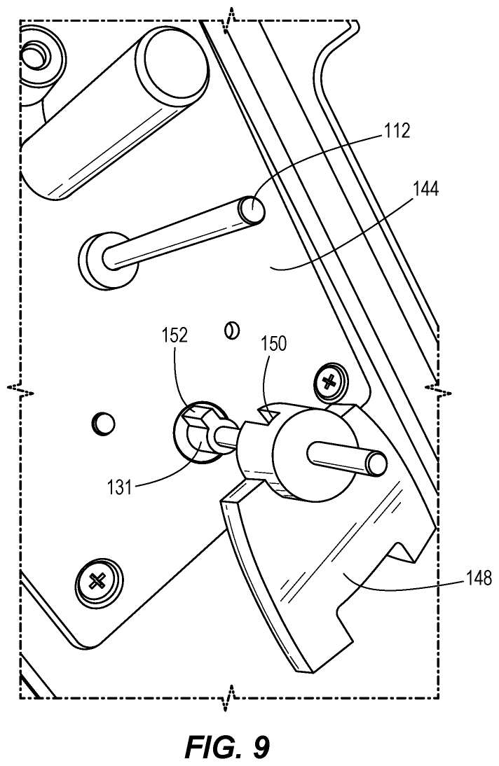

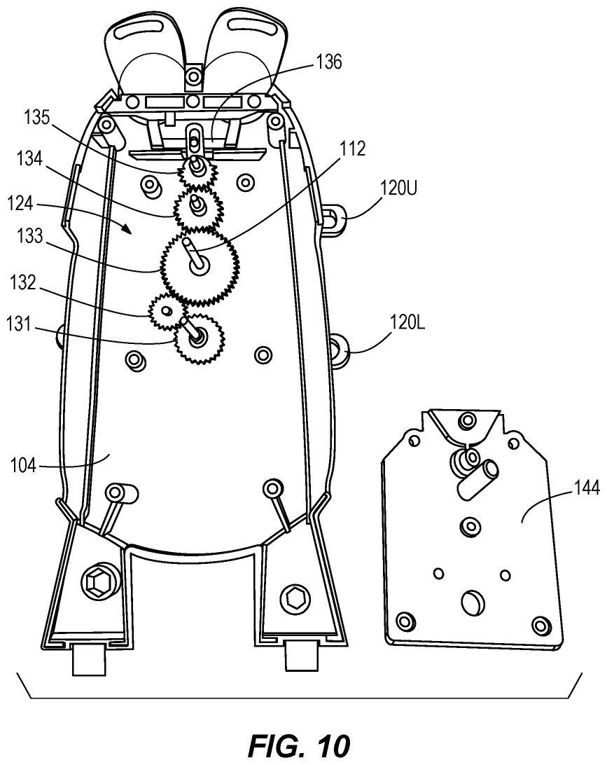

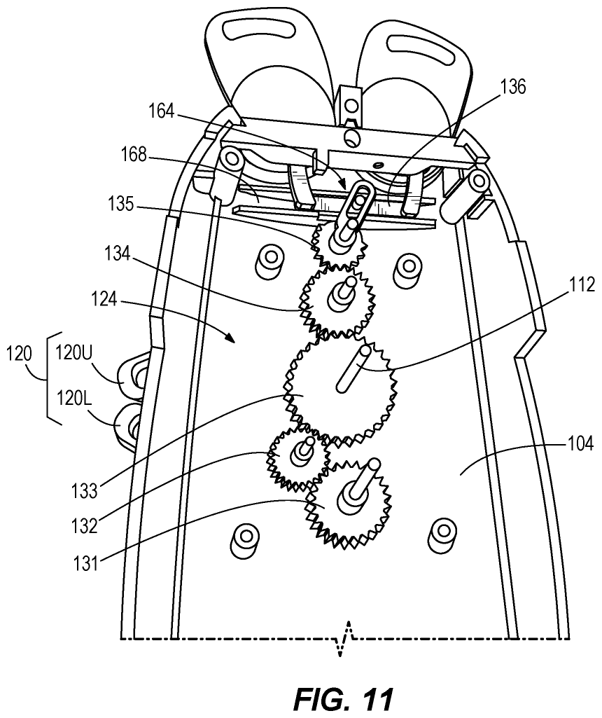

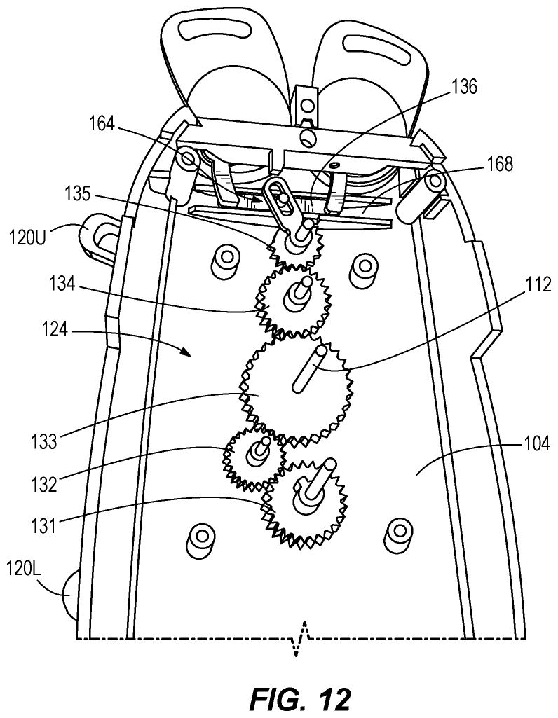

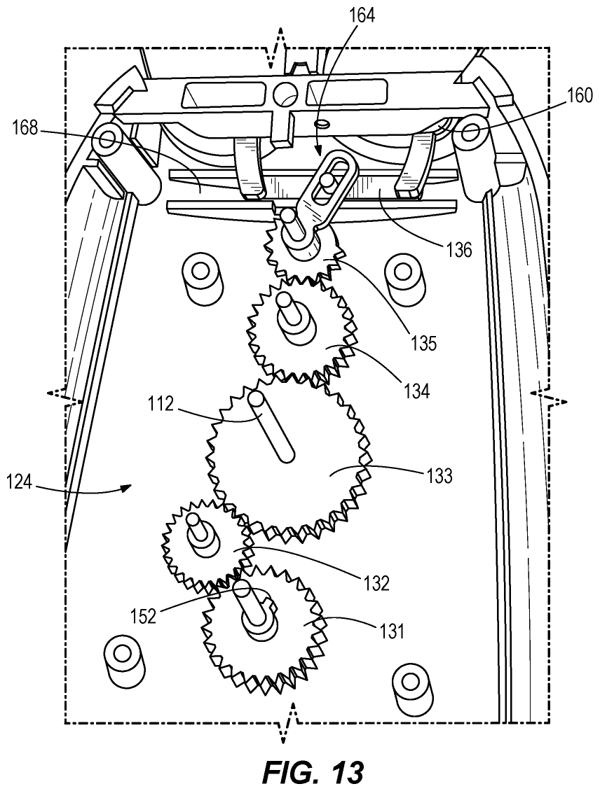

In some constructions, the display 120 is a mechanical display movably positioned on the front surface of the central portion 104. The mechanical display 120 is mechanically connected to the lever 108 and configured to contort between the greater-than sign (FIG. 1), the less-than sign (FIG. 2), and the equals sign (FIG. 3) in correlation with different orientations of the lever 108. In the illustrated construction, the mechanical display 120 includes two members: a lower member 120L and an upper member 120U (labeled separately in FIGS. 10-12). Each member 120L, 120U is straight or linear as viewed from the front. The two members 120L, 120U of the mechanical display 120 are rotatably linked by an internal mechanism 124 (FIGS. 10-13) to rotate in opposite directions in response to movement of the lever 108 about the fulcrum 112. In some constructions, the internal mechanism 124 includes a gear train. According to the illustrated, non-limiting example, the gear train includes a first gear 131 driven by movement of the lever 108, a second gear 132 driven by the first gear 131, a third gear 133 driven by the second gear 132, and a fourth gear 134 driven by the third gear 133. The first gear 131 and the fourth gear 134 are the same size (i.e., same diameter, same tooth count). The second gear 132 and the third gear 133 provide an overall 1:1 gear ratio between the first and fourth gears 131, 134. As such, the first and fourth gears 131, 134 are linked to rotate in equal, opposite amounts during operation. The lower and upper members 120L, 120U of the mechanical display 120 are fixed, respectively, to the first and fourth gears 131, 134. The fulcrum 112 is located at a central rotation axis of the third gear 133. As such, the fulcrum 112 defines a lever pivot axis vertically positioned between central rotation axes of the first gear 131 (and with it the lower member 120L of the mechanical display 120) and the fourth gear 134 (and with it the upper member 120U of the mechanical display 120). As shown in at least FIG. 10, the gear train is covered by a cover panel 144 that is securable to a front panel of the central portion 104 (e.g., with screws). The cover panel 144 can include a plurality of apertures and/or journals. As illustrated, the cover panel 144 has apertures for the passage of the fulcrum 112 and a portion of the first gear 131 as shown in FIG. 9. Additional journals in the cover panel 144 support axles of the gears.

With reference to FIGS. 4-9, a mechanical connection between the lever 108 and the internal mechanism 124 is an intermittent connection having a connected central range of motion (FIGS. 4, 5, and 7) and disconnected distal ranges of motion (FIGS. 6 and 8). As will become apparent, these ranges of motion also apply to the lever 108. The intermittent connection includes a drive portion 140 of the lever 108 and a bell crank 148. The drive portion 140 is located centrally along the length of the lever 108. The drive portion 140 is offset vertically from the fulcrum 112. The bell crank 148 is directly or indirectly connected to the internal mechanism 124 to rotate the first gear 131. As illustrated, the bell crank 148 and first gear 131 have complementary key parts 150, 152 (FIG. 9). As illustrated, the drive portion 140 is formed as a tooth or cog and the bell crank 148 includes a complementary recess 154. In other constructions, the shapes may be altered or reversed.

In the horizontal orientation of the lever 108 (FIGS. 3 and 4), the drive portion 140 is positioned within the recess 154 in the bell crank 148. In this configuration, which is the “equals” configuration, the drive portion 140 is operable to directly drive the bell crank 148 in either direction in response to rotation of the lever 108. As such, even a small amount of lever rotation begins to drive the internal mechanism 124 that controls the mechanical display 120. This feature enables the mechanical display 120 to accurately change from “equals” to either “greater than” or “less than” even when the difference between the loads at the two lever ends 108A, 108B is small. See for example, FIGS. 5 and 7 in which the lever 108 is at the ends of the central range of motion. The central range of motion may be +/−15 degrees or +/−20 degrees, for example. From the limits of the central range of motion, further rotation of the lever 108 occurs without the drive portion 140 further driving the bell crank 148. FIGS. 6 and 8 illustrate the distal ranges of motion. Here, the mechanical display 120 will simply match the “greater than” and “less than” configurations of FIGS. 5 and 7, respectively, despite substantially greater rotation angles of the lever 108. In the distal ranges of motion shown in FIGS. 6 and 8, the drive portion 140 is no longer contained within the recess 154 of the bell crank 148. In other words, the lever 108 and the mechanical display 120 (via the internal mechanism 124) are no longer in driving relationship. Rather, the drive portion 140 assumes a position that simply blocks the rotation of the bell crank 148 back to its central or neutral position so that the “greater than” or “less than” configuration is maintained at the mechanical display 120.

In some constructions, the gear train of the internal mechanism 124 further includes a fifth gear 135 driven by the fourth gear 134 and an output member 136 driven by the fifth gear 135. The output member 136 includes a pair of eyes 160 for a character face represented on the central portion 104. The eyes 160 are movable in conjunction with the two members 120L, 120U of the mechanical display 120 such that the eyes 160 are configured to move toward a greater one of the respective loads positioned at the distal ends 108A, 108B of the lever 108 (e.g., the greater number of objects B). In the case of equal loads positioned at the distal ends 108A, 108B of the lever 108, the eyes 160 point straight ahead rather than at either one of the loads. The eyes 160 of the output member 136 may project through corresponding openings in the central portion 104. The remainder of the output member 136 may be hidden inside the central portion 104. The fifth gear 135 and the output member 136 are connected via a pin and slot interface 164 so that the output member 136 can be actuated for sliding (e.g., horizontal) in response to rotation of the fifth gear 135. The output member 136 can be a slider restrained to horizontal sliding motion with respect to the central portion 104. As such, the interior of the central portion 104 can include a channel or groove 168 that receives the output member 136.

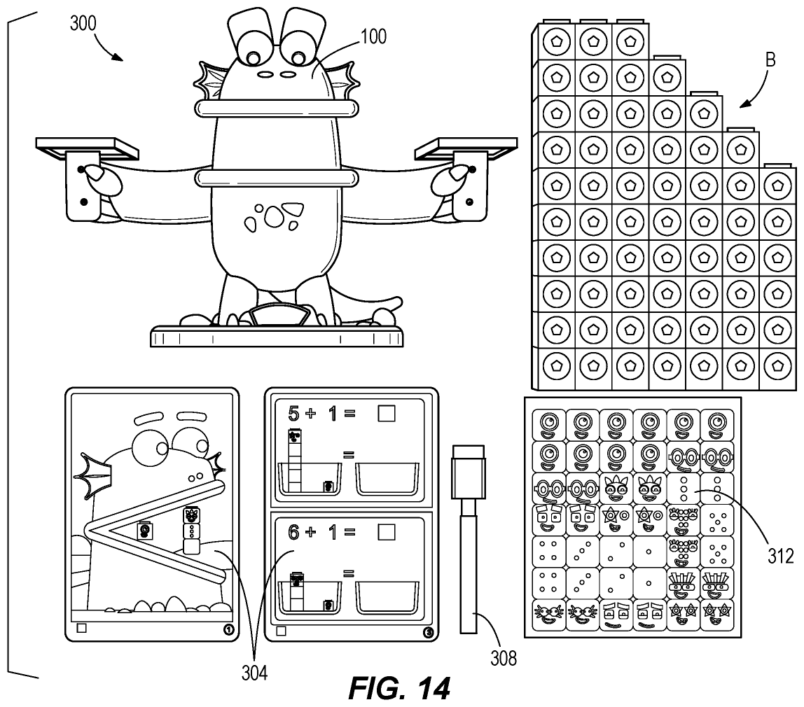

The balance 100 can be provided as part of a learning balance activity set 300 shown in FIG. 14. The activity set can include, in addition to the balance 100, any one or more of the following: books, software, activity sheets, manipulatives, multiple groups of different-colored objects B, a plurality of math activity cards 304, a dry erase marker 308 for use on the cards 304, and a variety of stickers 312 for application to the objects B. The balance 100 is configured to change the display 120 from = to either > or < when there is a difference of as little as 1 of the supplied objects B at the two ends of the lever 108.

Although some aspects have been described in detail with reference to certain preferred embodiments, variations and modifications exist within the scope and spirit of one or more independent aspects as described. Various features and advantages of the invention are set forth in the following claims.

What is claimed is:

1. A balance comprising:
a central portion;
a lever pivotably coupled to the central portion about a fulcrum centered along a length of the lever, the lever having opposing distal ends thereof; and
a display positioned on a front surface of the central portion,
wherein the display is configured to change between a greater-than sign, an equals sign, and a less-than sign in correlation with different orientations of the lever such that the display is operable to show a symbolic relationship between respective loads positioned at the respective opposing distal ends of the lever.

2. The balance of claim 1, wherein the display is a mechanical display that includes two linear members rotatably linked by an internal mechanism to rotate in opposite directions in response to movement of the lever about the fulcrum.

3. The balance of claim 2, wherein the internal mechanism includes a gear train.

4. The balance of claim 3, wherein the gear train includes a first gear driven by movement of the lever, a second gear driven by the first gear, a third gear driven by the second gear, and a fourth gear driven by the third gear.

5. The balance of claim 4, wherein the first gear and the fourth gear are the same size, and wherein the second gear and the third gear provide an overall 1:1 gear ratio between the first and fourth gears.

6. The balance of claim 4, wherein the fulcrum is located at a central rotation axis of the third gear.

7. The balance of claim 4, wherein the gear train further includes a fifth gear driven by the fourth gear and an output member driven by the fifth gear, wherein the output member includes a pair of eyes for a character face represented on the central portion, the pair of eyes being movable in conjunction with the two linear members of the mechanical display such that the eyes are configured to move toward a greater one of the respective loads positioned at the respective opposing distal ends of the lever.

8. The balance of claim 7, wherein the fifth gear and the output member are connected via a pin and slot interface, and the output member is a slider restrained to horizontal sliding motion with respect to the central portion.

9. The balance of claim 2, wherein a mechanical connection between the lever and the internal mechanism is an intermittent connection having a connected central range of motion and disconnected distal ranges of motion.

10. The balance of claim 1, further comprising removable containers with upstanding walls at the respective opposing distal ends of the lever.

11. The balance of claim 1, wherein the central portion includes a base and a pedestal extending upwardly from the base, and the pedestal is shaped to form a face of a character.

12. A learning balance activity set comprising:
the balance of claim 1;
a plurality of same-weight objects; and
a plurality of math activity cards.

13. A balance comprising:
a mechanical display including first and second members movably positioned on a front of the balance; and
a gear train configured to drive the first and second members of the mechanical display in response to movement of a pivotable lever,
wherein the first and second members are fixed to respective gears of the gear train that are linked to rotate in equal, opposite amounts to change the mechanical display between a greater than sign, an equals sign, and a less-than sign.

14. The balance of claim 13, wherein the gear train includes a first gear driven by movement of the lever, a second gear driven by the first gear, a third gear driven by the second gear, and a fourth gear driven by the third gear.

15. The balance of claim 14, wherein the first gear and the fourth gear are the same size, and wherein the second gear and the third gear provide an overall 1:1 gear ratio between the first and fourth gears.

16. The balance of claim 14, wherein the lever is pivotably supported at a fulcrum located at a central rotation axis of the third gear.

17. The balance of claim 14, wherein the gear train further includes a fifth gear driven by the fourth gear and an output member driven by the fifth gear, wherein the output member includes a pair of eyes for a character face represented on the front of the balance, the pair of eyes being movable in conjunction with the first and second members of the mechanical display such that the eyes are configured to move toward a greater one of a set of two loads supported, respectively, on opposite distal ends of the lever.

18. The balance of claim 17, wherein the fifth gear and the output member are connected via a pin and slot interface, and the output member is a slider restrained to sliding motion.

19. The balance of claim 13, wherein a mechanical connection between the lever and the gear train is an intermittent connection having a connected central range of motion and disconnected distal ranges of motion.

20. A learning balance activity set comprising:
the balance of claim 13;
a plurality of same-weight objects; and
a plurality of math activity cards.
